(19) United States
(12) Patent Application Publication
(10) Pub. No.: US 2010/0106481 A1
(43) Pub. Date: Apr. 29, 2010

(54) INTEGRATED SYSTEM FOR RECOGNIZING COMPREHENSIVE SEMANTIC INFORMATION AND THE APPLICATION THEREOF

(76) Inventor: Yingkit Lo, Hong Kong (CN)

Correspondence Address: SCHMEISER, OLSEN & WATTS, 22 CENTURY HILL DRIVE, SUITE 302, LATHAM, NY, 12110, US

(21) Appl. No.: 12/530,543

(22) PCT Filed: May 4, 2008
(86) PCT No.: PCT/CN2008/000896

§ 371 Date: Sep. 15, 2009

(30) Foreign Application Priority Data
Oct. 9, 2007 (CN) 200710030770.0

(51) Int. Cl. G06F 17/28; G06K 9/18; G06F 17/27

(52) U.S. Cl. 704/2; 382/185; 704/9; 704/E17.001

(57) ABSTRACT

The present invention discloses a kind of integrated system to recognize comprehensive semantic information, comprising: an information receiver module, to receive information source expressed by any kind of natural languages or texts; a conversion module, to convert the said information source into the semantic information database according to its semantic meaning; a semantic database, composed of Chinese words, in which the Chinese characters are encoded as digits which can be used in computer system according to the coding scheme of radical attribute; and an output module, to convert and output the said digits. The present invention can comprehensively recognize any kind of information source which are expressed by texts or languages, capture all kinds of information or digital information through the electronic system, and comprehensively understand and recognize all these information according to the Chinese words semantic meanings, and then respond with integrated data in simulation way. The present system can be applied in the fields of texts translation, language interpretation and searching, and thus greatly improves their efficiency and performance.

### FIELD OF THE INVENTION

The present invention relates to the field of computer technology, especially the integrated coding scheme for artificial intelligence applied in computer systems.

### BACKGROUND OF THE INVENTION

Enabling machines to recognize comprehensive semantic information provided by human beings has been a difficult problem. Machines can be utilized only when they can understand and recognize comprehensive human semantic information correctly and automatically, and thus communicate and respond precisely. However, semantic information typically includes various ambiguities. The aim for communication is to deliver information with their specific semantic meaning. Accordingly people use natural languages and texts to express information or meanings, and numerous kinds of languages and text systems have emerged.

In fact, as the world has been ever developing, information and semantic content associated with different kinds of languages and text systems, needing to be transmitted and expressed have become more abundant. However each kind of language and text system has faced similar chaotic situations that ordinarily involve numerous semantic confusions and misunderstandings due to abundant homonyms and synonyms. That is why it is difficult for machines to recognize precisely. The aim of the semantic coding is to enable machines to automatically recognize the semantic information of human beings in full scope, with the information being synthetically coded with one kind of standard semantic symbols. Chinese characters not only exist as a kind of natural language and text system, but also exist as the only kind of system with semantic symbols which can universally correspond to all semantic meanings of any natural language and text system. Meanwhile, the special structure of Chinese semantic symbology makes it easier for machines to search, judge and recognize the semantic information at high efficiency rate with short and fixed-length data.

Other communicative characters, besides Chinese characters, are usually alphabetic writings, with one or more phonetics composed of several letter symbols to express certain semantic meanings. The alphabetic writings come from phonetics which are composed of several letter strings and express certain specific semantic information. But the letter symbols themselves do not have any semantic meaning. Chinese characters are the oldest characters still being used in the world, with a frequency of usage comparable to English. Up to this moment, Chinese is the only kind of natural language with abundant texts system and brief expression ability.

A Chinese word can be a single Chinese character itself or be organically combined by two or three or four Chinese characters so as to express various semantic meanings. The examples for one-character-word are [symbol] (book), [symbol] (tree) and [symbol] (light); for two-character-word are [symbol] (clothes), [symbol] [symbol] (airplane) and [symbol] (teacher); for three-character-word are [symbol] (TV set), [symbol] (pilot) and [symbol] (travel agency). During the over three hundred years of exchange and amalgamation of civilization between the East and the West and the associated impact of globalization, the semantic expression structure of the Chinese words can virtually correspond and be translated to the semantic information of any natural languages and texts.

Since the aim of the existing coding methods is to record and save text in electronic way, they are encoded with each unique letter symbol. For example, the 256 code points of ASCII can represent English and western letters. Chinese character coding method includes Big5 Traditional Chinese, GB2312 Simplified Chinese, GB18030 Simplified Chinese and the Unicode which contains almost all kinds of characters in the world. The Chinese characters are numerous, and different character sets have different number of character forms. For example, the number of characters sets for GB2312 Simplified Chinese is 6700, whereas Big5 Traditional Chinese is 13500 and GB18030 Simplified Chinese is 18030. As a principle, these coding schemes record the unique glyph and code with corresponding number, of forms in order to meet the coding needs with multi-bytes data.

The earliest coding schemes were mainly coded with every single letter or character, and the letter symbols were coded into 128, 256 or 65,536 code points respectively, representing different semantic meanings by variable length letter strings. Computers were invented in the West, therefore alphabetic writings were initially implemented in computer coding schemes. For the widely used symbol coding rule of ASCII and ANSI, each letter or symbol is 1 byte and each byte is 8-bits length long.

Since only 128 most generally used letter symbols are prescribed in ASCII, and the quantity of computer character sets has been ever increasing, many extended coding schemes in ASCII have appeared. During the rapid development in information technology industry, a great deal of texts have been accumulated for recording purposes, which texts are composed by different letters, numbers and character symbols. The huge quantity of text and data often needs powerful computation by machine so as to meet the needs of searching in expanding data. For ordinary computers or electronic systems, the total number of the symbol code pointers directly affects the searching efficiency of words. In the enormous world of electronic information and huge databases, the efficiency of sequencing and sorting the symbol code pointers in large numbers is much lower than that in small numbers.

There are many kinds of text and language systems, all of which have one common characteristic, i.e. there exist many homonyms, polysemy or homophones as well as synonyms or hyponyms. The definition of homonym or homophone is that the same word or phrase or the same pronounced phrase has different semantic meanings in different situations. This is an inevitable phenomenon with the development of any natural language and texts. To distinguish these characteristics by automatic cognition will eventually generate the problem of facing homonyms with ambiguity, especially in confirming the correct meaning according to the context. In fact, this is still the puzzle for the automatic translation systems. People can determine the right semantic meaning of the homonyms according to the context when using the familiar language and texts system. As a result the existing technology can only be used to recognize language or texts in a limited scope. When homonyms appear in a limited local scope, it is impossible to confirm automatically the correct semantic meaning in accordance with the context.

All alphabetic writings are composed of letter strings in different length, the structure of which does not have a function of classification that directly corresponds with the radical system of Chinese characters. When it is necessary for machines to confirm the semantic meaning of homonyms automatically, there will be confused multi-semantic meanings. From the ancient Chinese society to the present, Chinese character system is different from alphabetic writings, because the characteristics and functionalities inherent to Chinese characters themselves have fixed primary semantic meanings corresponding to various radicals, which explain and represent the attributes of the Chinese characters containing or related to the primary semantic meanings. For example, the radical semantic part of [symbol] is pathological; the radical semantic part of [symbol] is something related to water; the radical semantic part of [symbol] is something related to metal, etc. Its usage in modern Chinese character system has 214 sorts of Chinese radicals.

Chinese characters are composed of radical and components. Only the structure of the radical has the function of primary semantic classification, especially in aspects of disambiguation. Mostly the characters related to the same content will have the relative radicals. For example, the radical [symbol] relates to pathology and the radical [symbol] relates to medical. The characters or the phrases containing these related radicals always appear in the same context. When it is needed to confirm the right meaning of homonyms, the characters or phrases with the same pronunciation but irrelative radicals can be excluded according to the principle of radical classification. Any natural language and texts system can be translated with the correct semantic meanings associated with relevant Chinese characters and phrases. However, none of the existing Chinese coding schemes have been ever coded with the semantic meanings of the Chinese radical attributes.

On the other hand, there are many synonyms which have the same semantic meaning but with different spellings in any alphabetic writing or language system. For example, the English word “Britain” has eight different ways of spelling having the same meaning such as England, UK, U.K., United Kingdom, GB, G.B., Britain and Great Britain, which can be respectively translated into Chinese texts of [symbol] [symbol] and [symbol] [symbol] but with the same Chinese semantic meanings interpreted as [symbol] . At present, there is no highly efficient method for clustering correctly and defining the right meaning of the synonyms automatically. If the user wants to search only for the specific semantic meaning, he has to submit quite a few searching requests with keywords or different phrases, to get the specific searching results in the widest range for consideration.

For the existing phonetics and text searching methods, the matching pronunciation or text are searched in the same text and further exchanged or translated to another natural language according to the same semantic meaning through dictionaries. Additionally, for the general synonym searching methods, all the different keywords of the specific language which represent the same semantic meaning need to be input respectively, so as to get the matching keywords of the same language. In fact, what the user wants is the specific semantic meaning itself, which however, is represented by many different keywords existing in the enormous Information World and needed to be further searched by the input of different keywords. The difficulty of searching in alphabetic writings is that it is necessary to search one specific meaning in the vast non-structural text with several said keywords. If it is possible to search the specific semantic meaning with a unique keyword, the searching scope will be greatly reduced and thus searching efficiency will be drastically enhanced.

The existing full-text searching is to be proceeded by using matching within the same text. In reality, what the user needs to search is some kind of specific semantic concept or related semantic meaning. To minimize the number of Chinese keywords for representing the synonym or hyponyms in different languages is the most efficient way to define and recognize data automatically. In the past, the small quantities of structural data could be classified manually into directory for searching, but it is easy to cause classification ambiguity due to the operator's diversified standard of recognition. At present as the information data have been accumulated and existed in tremendous quantity, it is necessary to have a simple and standard algorithm for sequencing and sorting the data automatically. Indeed, data is inter-related with one another rather than independent, so it is difficult to generate standardized definition and classification manually. Instead, it is needed to build up a highly efficient automatic system for processing structural data and even upcoming data in the relational database.

The existing letter or character coding scheme aims at recording text information in a wide scope. However, such a wide scope can only satisfy the basic requirements of text processing and storage in the past. Only after numerous information have become data of integrative structure can it be possible to have all this data utilized and mined in the widest and deepest degree. In existing technology, the same semantic metadata are defined manually, so that the metadata can be classified and clustered automatically for data mining. The purposes of structural clusters or digitize texts is to set up a semantic index. But for phrases composed of alphabetic writings, it is easy to produce deviated meanings when they are mixed used and used together, thus making it difficult to exclude the wrong meanings automatically. The method of labeling primary semantic data with radicals can precisely define and distinguish the relationship and the attribute between all semantic data.

### SUMMARY OF THE INVENTION

The present invention is to provide a practical system which can be used to integrative recognize all useable natural language or text expression from the source of information and to achieve the function of text retrieval and translation etc.

The present invention is also to create a controllable electronic machine which can be used to apply the said system to recognizing all natural languages by vocal input or commands.

For the sake of said purpose, the present invention provides an integrated system to recognize comprehensive semantic information, including:

an information receiver module—to receive information source expressed by all kinds of natural languages or texts; and

a conversion module—to convert the said information source into the semantic information database based on their semantic meanings; and

a semantic database—composed of Chinese words, in which the Chinese characters are encoded as digits commonly applied in computer system in accordance with the radical attribute coding scheme; and

an output module—to convert and output the said digits.

The said radical attribute coding scheme means that the Chinese character is split into at least one stroke according to the preset strokes set and stroke sequence, corresponding to the digit one by one, for each digit representing 1 byte, each byte being expressed by 3 bits value at most.

The preset strokes set is composed of dot [symbol] representing strokes of dot and the similar ones, short-slant [symbol] representing strokes of short slant and the similar ones, long-slant [symbol] representing strokes of long slant and the similar ones, short-stick “-” representing stokes of short stroke and the similar ones, and long-stick “—” representing stokes of long stroke and the similar ones.

In order to improve the system efficiency, the said represented digits are limited to digits 1, 2, 3, 4, 5, corresponding to dot [symbol] , short-slant [symbol] , long-slant [symbol] , short-stick “-” and long-stick “—” respectively. The insufficient part is represented by digit 0.

In order to further to simplify and confirm the Chinese character encoding for improving system efficiency, it is prescribed that the said Chinese characters are expressed by two groups of totally 6 digits, for each digit representing 1 byte and each byte represented by no more than 3 bits binary value, according to the structure of character pattern. Shown below is the expression of the 6 digits corresponding to the binary value.

| Digit | 3 bits binary value |
|---|---|
| 0 | 000 |
| 1 | 001 |
| 2 | 010 |
| 3 | 011 |
| 4 | 100 |
| 5 | 101 |

In order to effectively exclude the wrong ones among the various meanings of the homonyms or Synonyms, the said semantic database is divided into various cluster databases, in which Chinese words at the same field are clustered and classified according to the radical semantic attribute. The operation of the said cluster databases are implemented by comparing and matching the radical semantic attributes of the homonyms so as to define the suitable words.

Furthermore, the said receiver module can receive the sense information or action information which are eventually converted into Chinese words and encoded as digits so as to enable them to be read by the computer.

To achieve the most efficient data search, the data need to be arranged according to combination sequence of letters or figures or symbols, and then to be searched and matched. The present invention can recognize any semantic information by Chinese words. Corresponding to any semantic data, each Chinese character is composed of different radicals or components, and each component is composed of different strokes. In the present invention, the least strokes are used to correspond to the digit set of different radicals or components. The strokes are corresponding to different digits; each digit is 1 byte, and each kind of stroke is 3 bits binary value at most. Each Chinese character is composed of 6 bytes at least, with code points in fixed length. As compared with the variable length data of the alphabetic writings, the sequencing efficiency of sorting must reach the highest level.

Since a vast range of information in form of digital data comes out every day, the database needs to be updated and sorted in order simultaneously when new data are inserted, which is a process repeated all along. Therefore, it is necessary to develop a highly efficient integrated coding scheme for data sorting. In the present invention, the Chinese words are integrated and corresponding to the semantic information of any natural languages and texts, and the semantic meanings can be sorted with the digit set of the least code point.

In the present invention, the Chinese words can correspond to information expressed by any natural language or texts. Chinese is one kind of natural languages. The Chinese character system is supported with radical system and any Chinese words can be automatically clustered and classified according to their radical attribute. In fact, any kind of natural language or texts information can be automatically recognized corresponding to the Chinese words, and the ambiguity can be eliminated automatically. For the existing language and text translation systems, the original contents have various meanings, and thus it is difficult to define spontaneously so that the relationship between the homonyms and the context. For the present invention, any natural languages and texts can be automatically translated into another natural languages and texts. According to the classifiable radical attribute of Chinese words, the contents with ambiguity can be defined correctly and automatically.

Apart from languages and texts, the recognizing way includes sight, hearing, taste and touching. For example, when seeing something in red, we will can associate the semantic information of passion, danger or stop. We can distinguish between leisurable, relaxed, agile and noisy voices through hearing. When tasting something, we perceive the sweet, acetous, bitter or peppery qualities etc. We can also feel whether it is a light pat or a heavy beat though our physical sensory perception. The above mentioned senses can be captured through different electronic systems and commonly stored as digitized semantic data. The present invention can match the sense information expressed by the different levels of digit with corresponding Chinese words. For example, the digitization of color depth is expressed by three primary colors (R,G,B). For instance, “255,0,0” represents red, corresponding to the Chinese words encoded of [symbol] (red); “0, 255, 0” represents green, corresponding to the Chinese words encoded of [symbol] (green), etc. Also people can communicate by other means, such as facial expression, gesture or body action. The facial expression captured through the automatic recognition systems needs to be expressed with corresponding semantic words. For example, the facial semantic information of lips shape being raised up with teeth exposed correspond to the Chinese word [symbol] (smile). The action semantic information of nodding correspond to the Chinese word of [symbol] (allow) or [symbol] (agree). For the body action, the semantic information patting two hands correspond to the Chinese word of [symbol] [symbol] (applause/clap), [symbol] (appreciation) or [symbol] (welcome). The present invention can capture all these kinds of data through different electronic systems, comprehensively understand and recognize them according to the semantic meanings of Chinese words, and then respond with actions by simulated data.

For the present invention, the Chinese character coding system and method are represented with digit set. One set of digits for the Chinese character is corresponding to the radical attribute so that the system can recognize the semantic information according to various radical attributes.

To achieve highly efficient data searching, any semantic information such as natural language or texts should be fully structured so that the most accurate classification with the least data can be attained. The present invention uses the radical attribute of Chinese character to classify all kinds of semantic information. Knowledge appears in different aspects and comes down and spreads by means of “words”. Different knowledge fields contain specific semantic meanings. In the Chinese character system, specific semantic meaning is expressed by the specific radical. For example, the radicals regarding medical include [symbol] , [symbol] and [symbol] which are corresponding to the Chinese words of [symbol] (sick), [symbol] (medicine) and [symbol] (turgescence). The said semantic database will be clustered and classified according to the radical attribute in different knowledge fields.

The present invention will focus on the searching of the semantic meaning itself, with Chinese words corresponding to different searching requests, and get the result according to the relationship between associated semantic meanings.

Machinery and electronic machines have been embodied in all kinds of daily application. But until now, only small parts of the vocal information can be converted into command sets to be used for recognition and control. The reason for incapability of recognizing comprehensive semantic information is the repetition of voice in any natural languages. There are too many homonyms causing ambiguities which can not be converted into the unique instruction or command to ensure accurate operation. It is long hoped that the mechanism of operation controlled by comprehensive natural languages can be achieved. But it is easy to have the mistakes in the process of recognition due to the homonyms. In the existing technology, the natural languages can be recognized in local and limited scope, like executing the requests for weather, ticket information or bank account details information request by vocal command which are converted into correct instructions, to store the data or further to be converted into the preset electro-mechanical actions. The present invention can accurately recognize comprehensive semantic information, including any natural language or texts information, which will be expressed and correspond to the instructions for operating mechanical and electronic machines. To carry out comprehensive vocal instructions, to encode radical attributes, to organize and cluster the semantic meanings, and to respond accordingly are also the methods of thinking and studying for the robot.

### BRIEF DESCRIPTION OF THE DRAWINGS

FIG. 1 is the flow chart of system structure of the present invention.

FIG. 2a is the coding scheme showing the corresponding relationship between stroke and the digits.

FIG. 2b is the coding method showing the examples of Chinese stroke types and the digits.

FIG. 3 is the flow chart of disambiguation for semantic meanings.

FIG. 4a shows the input contents of the natural language in the embodiments.

FIG. 4b shows the analysis of the radical attribute in relation to semantic meaning of the keywords within the input contents of FIG. 4a.

FIG. 4c shows the corresponding relationship between the radical encoded in digits for the keywords and the words.

FIG. 5 shows the corresponding relationship between the Chinese words and the English synonyms in the embodiment 3.

FIG. 6 shows the corresponding relationship between strokes of the keywords and the digit set.

### DETAILED DESCRIPTION OF THE PREFERRED EMBODIMENTS

Now the embodiments are further described and explained with reference to the drawings, the characteristics, the aims and the advantages of the present invention. The embodiments are only used to describe and explain the invention, but not limited to this invention.

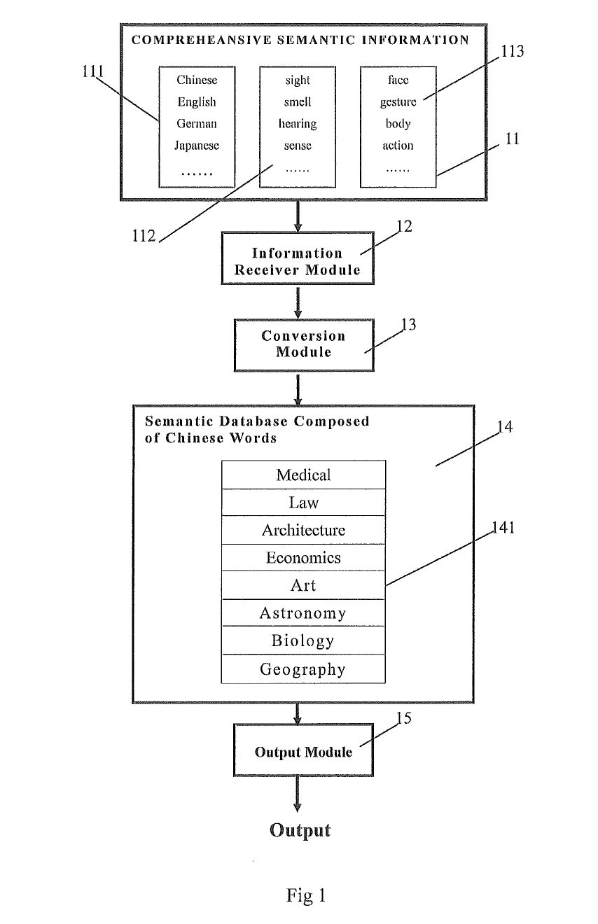

The system structure of recognition shown in FIG. 1 includes information receiver module 12, conversion module 13, semantic database 14, and output module 15.

The comprehensive semantic information set 11 includes any kind of the natural language and texts information 111, such as the phonetics and the words of Chinese, English, German, Spanish and Japanese; or any information that can be expressed by any kind of the natural language and texts such as vision, hearing, taste or the other sense information 112; and facial expression, gesture, body action or other action information 113. Information 11 is the input into the computer system through the information receiver module 12. Receiver module can include multi kinds of signal reception and data input devices, which can receive the information like sound, action and sense, and express them with words or texts finally. The reception and data input device can make use of the existing devices available so they are not to be elaborated herein.

The language or texts information are converted into semantic database 14 through conversion module 13 according to its semantic meaning. The semantic database 14 is composed of different Chinese words. The Chinese characters in the semantic database can be encoded as the digits to be applied in the computer system according to their coding scheme of radical attribute. The coding scheme of radical attributes means that the Chinese character is split into at least one stroke according to the preset strokes set and stroke sequence, corresponding to the digits one by one.

Encoded data is converted into digital data or simulated signal for output through the output module 15 to achieve the functions of retrieval or translation.

The preset strokes set is composed of dot [symbol] representing strokes of dot and the similar ones, short-slant [symbol] representing strokes of short slant and the similar ones, long-slant [symbol] representing strokes of long slant and the similar ones, short-stick “-” representing strokes of short stick and the similar ones, and long-stick “—” representing strokes of long stick and the similar ones.

In details, digits 1, 2, 3, 4, 5 are used as code elements, respectively representing such five types of strokes as dot [symbol] , short-slant [symbol] , long-slant [symbol] , short-stick “-” and long-stick “—”. When the stroke is insufficient, the insufficient part is represented by digit 0.

Chinese characters are classified into left-to-right form and top-to-down form characters, and also defined into single-component and joint-component characters. Each Chinese character is encoded with two sets of digits. According to the character structure, each Chinese character is expressed by two sets of six digits. There are only 6 code elements for the stroke combinations, expressed with binary value. Data length of each stroke is 3 bits value, so that data length of each Chinese character is 18 bits.

Now the said Chinese character coding scheme is explained with the embodiment.

### Embodiment 1

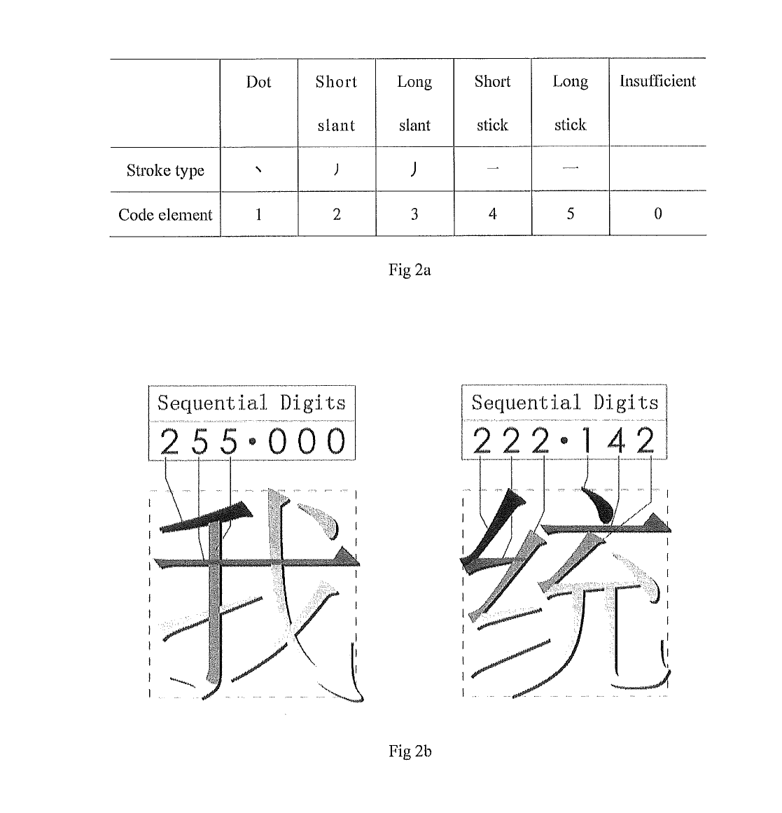

Referring to FIG. 2a, the five types of Chinese character strokes [symbol] , [symbol] , “-”, “—” are encoded with digit 1, 2, 3, 4, 5 respectively, while the insufficient part is encoded with digit 0, totally 6 code elements. For example, the Chinese character [symbol] as shown in FIG. 2b is a single-component character, with the first component stroke-set in sequence being encoded 255. Character [symbol] does not have other components, so the insufficient part is encoded 000. The entire code is 255-000. As for the example of character [symbol] the first component stroke-set in sequence is encoded 222, while the second component stroke-set code is encoded 142, so the entire code is 222-142.

To simplify the input process and improve the operation efficiency of in this present invention, the five types of Chinese character strokes are encoded with digit 1, 2, 3, 4, 5 respectively and the insufficiency is encoded with digit 0. But it is possible for the Chinese character strokes to be encoded with other 6 digits or even with letters, which is not beyond the realm of the present invention and also within the protection of the present invention.

The existing widely used natural languages and text systems have the same problem that there exist homonyms and synonyms with ambiguities. The homonyms in any kind of natural language and texts system can correspond to different Chinese words with different radical semantic attribute, i.e.,

| | | |
|---|---|---|
| Homonym A | Chinese word A | Radical semantic attribute |
| | | cluster 1 |
| Homonym B | Chinese word B | Radical semantic attribute |
| | | cluster 2 |
| . | . | . |
| . | . | . |
| . | . | . |
| Homonym n | Chinese word n | Radical semantic attribute |
| | | cluster n |

The semantic database 14 is provided with some words clusters 141. The Chinese words in the same aspect are clustered and classified according to the radical attribute, such as physics, laws, architecture, economics, art and astronomy. The peculiar classifiable function and properties of the Chinese radical is used to disambiguate both the homophony and the homonymy in order to define the right words of matched relationship.

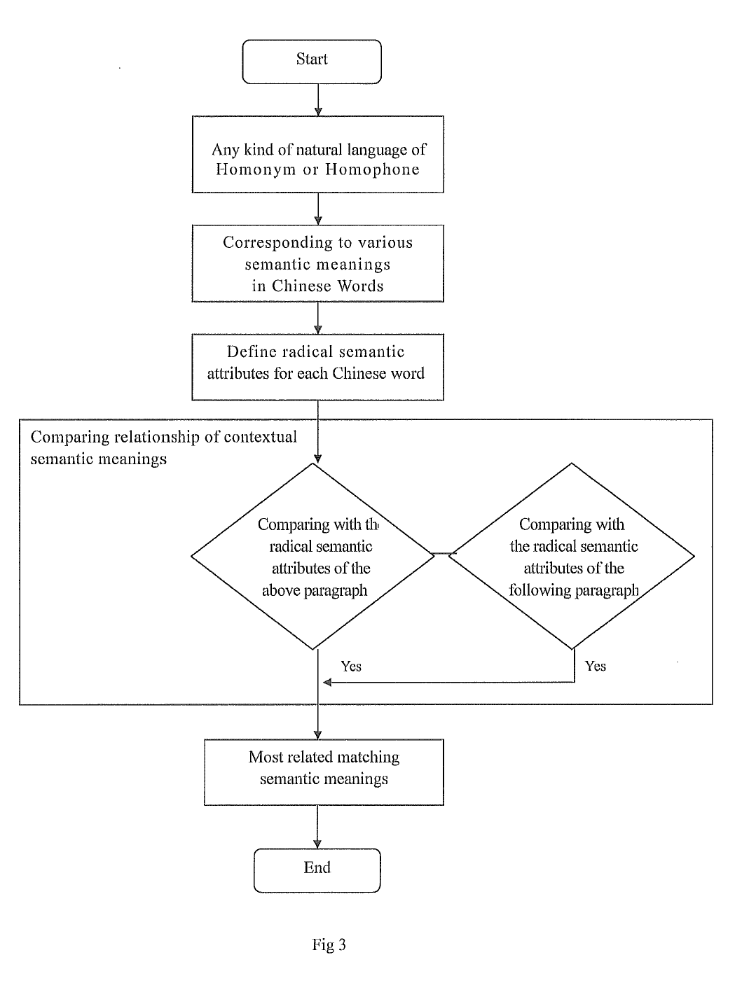

Disambiguating work flow is illustrated in FIG. 3.

Step 301 shows that when inputting any kind of the natural language or texts, the semantic meanings of contents will have ambiguities, namely the same word with different meanings or the same pronunciation with different words.

Step 302 shows that the homonym of the said words are corresponding to the Chinese words or phrases in the semantic database 14 respectively according to the semantic meanings through the conversion module.

Step 303 shows that Chinese words with different semantic meanings have different radical semantic attributes, which can be defined with the pattern of sequential digits.

Step 304 shows that the said different Chinese words shall be compared with and matched their context according to their semantic meanings. Actually, it is the radical semantic attribute which matches relationship of the context in radical semantic attributes.

Step 305 shows comparison with the radical semantic attribute of the above words and paragraphs.

Step 306 shows comparison with the radical semantic attribute of the following words and paragraphs.

Step 307 shows that the basic rule for matching the ambiguous words with the radical semantic attributes is that the words which mostly matches the contextual radical semantic attributes have first priorities.

Now the said flow is explained with the embodiment.

### Embodiment 2

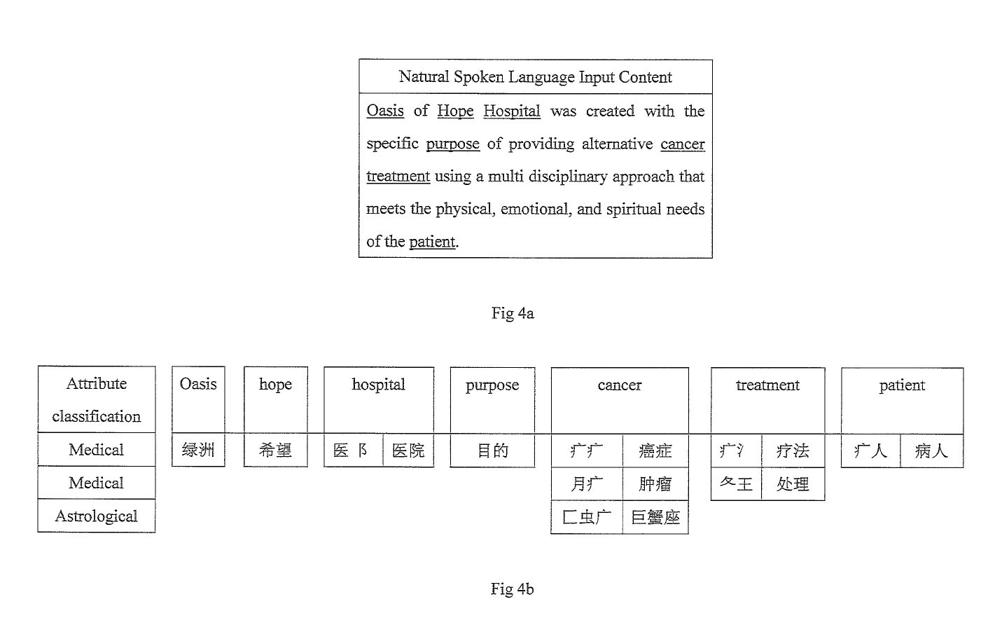

In any kind of the natural language system, it is common that one word has various meanings or one pronunciation has different spellings. When the said words are converted into digital data for recognizing the semantic meanings, the results come out with ambiguity. Referring to FIG. 4a, a passage speech of English in texts is input. Referring to FIG. 4b, the keywords of the said passage are analyzed for their radical semantic attributes. In the said passage, there is a homonym “cancer”. The English word “cancer” has different meanings in different situations. With reference to medical aspect, it means carcinoma and tumor. With reference to astrology, it means the CRAB. When corresponding to the Chinese words, there will be two different meanings and characters. The corresponding meaning of Chinese word [symbol] is carcinoma, the radicals of which are [symbol] Corresponding meaning of the Chinese word [symbol] is tumor, the radicals of which are [symbol] With reference to the CRAB, the corresponding Chinese word is [symbol] , the radicals of which are [symbol] referred to 402, in FIG. 4b. The word “hospital” at the above word means a large building in which people who are ill/sick or injured are given medical treatment and care, corresponding to the Chinese word [symbol] . The radical of [symbol] is [symbol] , as seen to 401. At the following word, the word “patient” means a person who is receiving medical treatment, especially in a hospital, corresponding to the Chinese word [symbol] . The radical of [symbol] is [symbol] . Referring to FIG. 4c, encoding digits of the said radical semantic meaning are 555 and 153. In the radical clustering database, radicals [symbol] and [symbol] are related to medical aspect, both of which are clustered in the same field. The word “cancer” in this context should be automatically defined as the semantic meaning related to pathology, so another meaning of CRAB will be excluded.

Similarly, the Chinese word [symbol] or [symbol] is corresponding to “treatment”. The radicals for [symbol] are [symbol] and [symbol] The radicals for [symbol] are [symbol] and [symbol] Comparing with the contextual, the matched word [symbol] will be chosen.

As usual, the searching process with the keywords is to search and to match within the database according to the spelling or writing of the keywords. When one semantic meaning has variable expressions, it is necessary to input all the various spellings to search for the relevant documents. As a result, so the process will become complicated, slow and inefficient. The present invention uses a unique Chinese word to express the semantic meaning corresponding to any kind of natural language and to search with, which will greatly reduce the number of searching data and improve the operation efficiency.

### Embodiment 3

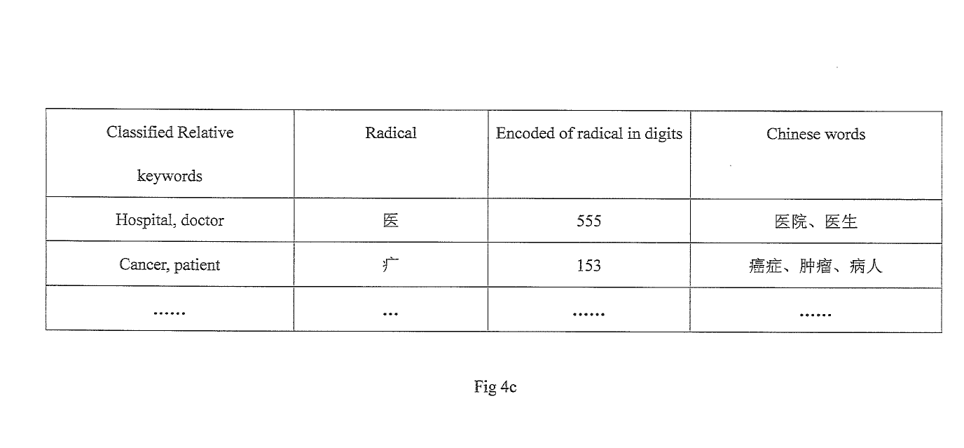

Referring to FIG. 5, 501 shows the letter string combinations corresponding to the word “Britain”, including England, UK, U.K., United Kingdom, GB, G.B., Britain and Great Britain, etc.

When it is needed to search the relevant documents containing the semantic meaning of the country “Britain”, the spellings can be England, UK, U.K., United Kingdom, GB, G.B., Britain or Great Britain. Therefore, it is probable to input all the spellings to find out the needed documents.

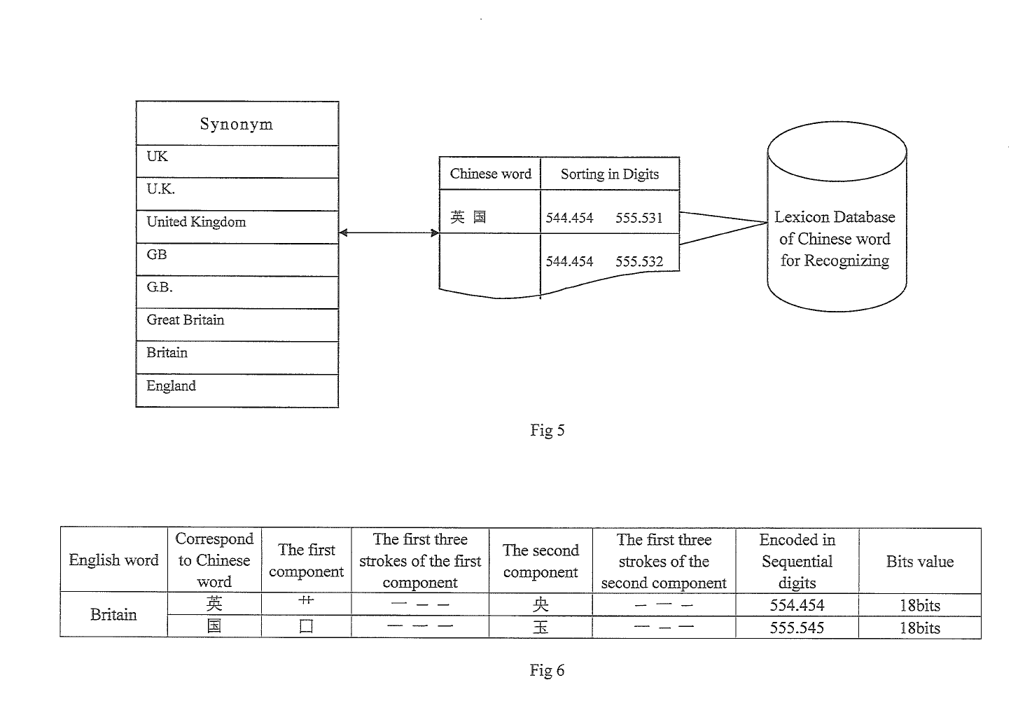

502 shows that all the spellings express the unique semantic meaning, thus corresponding to a unique Chinese word [symbol] . Referring to FIG. 6, the word [symbol] is corresponding to the digits encoded with 554.454 and 555.545. Each Chinese word can be expressed with six digit bytes, each byte of 3 bits value, so six bytes have a total value of 18 bits. 503 show the searching for the semantic meaning in the Chinese words database. In the present invention, when searching with the keywords, it is only needed to search the digit set 555.531 for the word [symbol] , then all the relevant words will appear, which will reduce the number of the keywords, simplify the searching process and minimize the data quantity.

### Embodiment 4

People have long wished to have Voice command or voice converted text instruction to control any electronic device or machine with an entire logic instruction. The present invention can correctly recognize the human comprehensive semantic information, including all kinds of natural language and texts semantic information, and also can express and correspond to the instruction for controlling the engine and the electronic machine. To carry out comprehensive voice instruction, to encode the radical attribute to digits, which can organize and cluster the related semantic meaning and to respond and feedback are also the methods of thinking and study for the robot.

What claimed is:

1. An integrated system to recognize comprehensive semantic information comprising:
an information receiver module, to receive information source expressed by any kind of natural language or texts;
a conversion module, to convert the said information source into the semantic information database according to its semantic meaning;
a semantic database, composed of Chinese words, in which the Chinese characters are encoded as digits which can be used in computer system according to radical attribute coding scheme; and
an output module, to convert and output the said digits;
wherein the radical attribute coding scheme means that the Chinese character is split into at least one stroke according to the preset strokes set and stroke sequence, corresponding to the digit one by one, for each digit representing one byte, each byte being expressed by 3 bits value at most.

2. A system according to claim 1, wherein the said preset strokes set is composed of dot [symbol] , representing strokes of dot and the similar ones; short-slant [symbol] , representing strokes of short slant and the similar ones; long-slant [symbol] , representing strokes of long slant and the similar ones; short-stick “-”, representing strokes of short stick and the similar ones; and long-stick “—”, representing strokes of long stick and the similar ones.

3. A system according to claim 2, wherein the said digits are composed of digits 1, 2, 3, 4, 5, respectively corresponding to dot [symbol] , short-slant [symbol] , long-slant [symbol] , short-stick “-” and long-stick “—”, with the insufficiency being expressed by digit 0.

4. A system according to claim 1, wherein the Chinese character is encoded with two sets of totally six digits according to its structure, each byte having 3 bits value at most.

5. A system according to claim 2, wherein the Chinese character is encoded with two sets of totally six digits according to its structure, each byte having 3 bits value at most.

6. A system according to claim 3, wherein the Chinese character is encoded with two sets of totally six digits according to its structure, each byte having 3 bits value at most.

7. A system according to claim 1, wherein the said semantic database is provided with classified knowledge cluster databases based on the Chinese radical classifiable function, in which Chinese words in the same field are clustered and classified according to the radical semantic attribute, and the said cluster databases are applied to compare and match the radical semantic attribute of the homonyms so as to define the matching words.

8. A system according to claim 1, wherein the said receiver module receives the sense information which is converted into character information with Chinese words, and is expressed as digits which can be read by the computer.

9. A system according to claim 1, wherein the said receiver module receives the action information data which are converted into character information with Chinese words, and are expressed as digits which can be read by the computer.

10. Applying the system according to claim 1 to structure information data of any natural language and texts.

11. Applying the system according to claim 1 to inter-translate and inter-interpret any two kinds of the natural language and texts systems.

12. An electronic machine applying the system according to claim 1 controlled by voice of any kind of natural language system.
